(19) United States
(12) Patent Application Publication
(10) Pub. No.: US 2026/0043929 A1
(43) Pub. Date: Feb. 12, 2026

(54) ELECTRONIC SYSTEM FOR SENSING ELECTROMAGNETIC RADIATION

(71) Applicant: Texas Instruments Incorporated, Dallas, TX (US)

(72) Inventors: Eduardo Bartolome, Dallas, TX (US); Nagesh Surendranath, Frisco, TX (US); Shriram Devi, Pune (IN); Karthik Nagabhushana, Bangalore (IN); Sreenivasan K. Koduri, Dallas, TX (US); Makarand R. Kulkarni, Plano, TX (US); Kathryn Schuck, Dallas, TX (US); Rafael S. Mendoza, Richardson, TX (US); Karthikeyan Kamatchi, Bangalore (IN); Paul CHen, New Taipei City (TW); Pao-Wei Tseng, New Taipei City (TW)

(21) Appl. No.: 19/292,080

(22) Filed: Aug. 6, 2025

Related U.S. Application Data
(60) Provisional application No. 63/679,934, filed on Aug. 6, 2024.

(51) Int. Cl. G01T 1/24; G01T 1/29

(52) U.S. Cl. CPC G01T 1/241; G01T 1/244; G01T 1/248; G01T 1/2985

(57) ABSTRACT

The present disclosure generally relates to an electronic system for sensing electromagnetic radiation. In an example, an electronic system includes a substrate having a first surface and a second surface, the second surface is opposite the first surface. The electronic system also includes a first semiconductor die on the first surface of the substrate, and a second semiconductor die on the second surface of the substrate. The first semiconductor die and the second semiconductor die are coupled to one another through an opening in the substrate by a bondwire.

This application claims priority to provisional application 63/679,934, filed Aug. 6, 2024, the contents of which are herein incorporated by reference in its entirety.

### BACKGROUND

Computed tomography (CT) systems can be used for medical imaging. Capturing many internal images of an object and combining the images to form a representation of the object. An internal image may be created by emitting electromagnetic radiation from a source, directed at an array of electronic systems, with the object placed therebetween. The electronic systems receive the electromagnetic radiation and convert it to electrical data that may be transmitted to a central processing unit. By repeating this process, multiple images of the object may be captured and subsequently combined by the central processing unit to provide a CT scan.

### SUMMARY

An example described herein is an electronic system. The electronic system includes a substrate having a first surface and a second surface, the second surface is opposite the first surface. The electronic system also includes a first semiconductor die on the first surface of the substrate, and a second semiconductor die on the second surface of the substrate. The first semiconductor die and the second semiconductor die are coupled to one another through an opening in the substrate by a bondwire.

Another example described herein is a computed tomography (CT) system. The CT system includes an electromagnetic radiation emitter and an electronic system. The electronic system includes a substrate having a first surface and a second surface, the second surface is opposite the first surface. The electronic system also includes a first semiconductor die on the first surface of the substrate, and a second semiconductor die on the second surface of the substrate. The first semiconductor die and the second semiconductor die are coupled to one another through an opening in the substrate by a bondwire.

Another example described herein is a method of using a computed tomography (CT) system. The method includes emitting an electromagnetic radiation signal, receiving the electromagnetic radiation signal at a scintillator, converting the electromagnetic radiation signal to light, and converting the light to an electrical signal using an electronic system. The electronic system includes a substrate having a first surface and a second surface, the second surface is opposite the first surface. The electronic system also includes a first semiconductor die on the first surface of the substrate, and a second semiconductor die on the second surface of the substrate. The first semiconductor die and the second semiconductor die are coupled to one another through an opening in the substrate by a bondwire.

Another example described herein is an electronic system. The electronic system includes a flexible film. The electronic system also includes a first electronic device couple to a first surface of the flexible film through a plurality of contacts arranged along an edge of the first electronic device. The electronic system also includes a second electronic device couple to the first surface of the flexible film.

Another example described herein is a computed tomography (CT) system. The CT system includes an electromagnetic radiation emitter and an electronic system. The electronic system includes a flexible film. The electronic system also includes a first electronic device couple to a first surface of the flexible film through a plurality of contacts arranged along an edge of the first electronic device. The electronic system also includes a second electronic device couple to the first surface of the flexible film.

Another example described herein is a method of using a computed tomography (CT) system. The method includes emitting an electromagnetic radiation signal, receiving the electromagnetic radiation signal at a scintillator, converting the electromagnetic radiation signal to light, and converting the light to an electrical signal using an electronic system. The electronic system includes a flexible film. The electronic system also includes a first electronic device couple to a first surface of the flexible film through a plurality of contacts arranged along an edge of the first electronic device. The electronic system also includes a second electronic device couple to the first surface of the flexible film.

Another example described herein is an electronic system. The electronic system includes a body. The body has a first surface and a second surface, opposite the first surface. The electronic system also includes a first flexible film. A first portion of the first flexible film is on the first surface of the body. The electronic system also includes a first electronic device on the first portion of the first flexible film. A first contact is on a second portion of the first flexible film. The electronic system also includes a second electronic device. The second electronic device is on the second surface of the body, and includes a second contact. The first contact and the second contact are coupled through an opening in the body.

Another example described herein is a computed tomography (CT) system. The CT system includes an electromagnetic radiation emitter and an electronic system. The electronic system includes a body. The body has a first surface and a second surface, opposite the first surface. The electronic system also includes a first flexible film. A first portion of the first flexible film is on the first surface of the body. The electronic system also includes a first electronic device on the first portion of the first flexible film. A first contact is on a second portion of the first flexible film. The electronic system also includes a second electronic device. The second electronic device is on the second surface of the body, and includes a second contact. The first contact and the second contact are coupled through an opening in the body.

Another example described herein is a method of using a computed tomography (CT) system. The method includes emitting an electromagnetic radiation signal, receiving the electromagnetic radiation signal at a scintillator, converting the electromagnetic radiation signal to light, and converting the light to an electrical signal using an electronic system. The electronic system includes a body. The body has a first surface and a second surface, opposite the first surface. The electronic system also includes a first flexible film. A first portion of the first flexible film is on the first surface of the body. The electronic system also includes a first electronic device on the first portion of the first flexible film. A first contact is on a second portion of the first flexible film. The electronic system also includes a second electronic device. The second electronic device is on the second surface of the body, and includes a second contact. The first contact and the second contact are coupled through an opening in the body.

### BRIEF DESCRIPTION OF THE DRAWINGS

For a detail description of various examples, reference will now be made to the accompanying drawings in which:

FIG. 1A is a perspective view of a computed tomography system, in accordance with various examples.

FIG. 1B is a top-down view of an array of electronic systems, in accordance with various examples.

FIG. 2A is a top-down view of an electronic system, in accordance with various examples.

FIG. 2B is a cross-sectional view of the electronic system of FIG. 2A, in accordance with various examples.

FIG. 2C is another cross-sectional view of the electronic system of FIG. 2A, in accordance with various examples.

FIG. 3A is a side view of an electronic system, in accordance with various examples.

FIG. 3B is a top-down view of the electronic system of FIG. 3A, in accordance with various examples.

FIG. 3C is a perspective view of the electronic system of FIG. 3A, in accordance with various examples.

FIG. 4A is a perspective view of an electronic system, in accordance with various examples.

FIG. 4B is an exploded view of the electronic system of FIG. 4A, in accordance with various examples.

FIG. 5A is a perspective view of an electronic system, in accordance with various examples.

FIG. 5B is a perspective view of another electronic system, in accordance with various examples.

FIG. 6 illustrates a method of using a computed tomography system, in accordance with various examples.

### DETAILED DESCRIPTION

In the drawings, like reference numerals refer to like elements throughout, and the various features are not necessarily drawn to scale. Also, the term “couple” or “couples” includes indirect or direct electrical or mechanical connection or combinations thereof. For example, if a first device couples to or is coupled with a second device, that connection may be through a direct electrical connection, or through an indirect electrical connection via one or more intervening devices and connections. One or more operational characteristics of various circuits, systems and/or components are hereinafter described in the context of functions which in some cases result from configuration and/or interconnection of various structures when circuitry is powered and operating. In the following discussion and in the claims, the terms “including,” “includes,” “having,” “has,” “with,” or variants thereof are intended to be inclusive in a manner similar to the term “comprising,” and thus should be interpreted to mean “including, but not limited to.”

Unless otherwise stated, “about,” “approximately,” or “substantially” preceding a value means +/−10 percent of the stated value. One or more structures, features, aspects, components, etc., may be referred to herein as first, second, third, etc., such as first and second terminals, first, second, and third dies, etc., for ease of description in connection with a particular drawing, where such are not to be construed as limiting with respect to the claims. Various disclosed structures and methods of the present disclosure may be beneficially applied to manufacturing a semiconductor device such as an integrated circuit. While such examples may be expected to provide various improvements, no particular result is a requirement of the present disclosure unless explicitly recited in a particular claim.

Computed tomography (CT) enables rendering of internal structures of certain objects, such as the internal organs of human beings. Electromagnetic radiation is emitted, often in the form of x-rays, and directed toward an array of electronic systems. The array of electronic systems receives the electromagnetic radiation and convert it to an electrical signal. One way to accomplish the conversion is to use a scintillator that is excited by the electromagnetic radiation and emits light near a photodiode to generate an analog signal. The analog signal may then be converted to digital information using an analog to digital converter. This digital information may then be processed by a central processing unit.

An electronic system often has a photodiode array (e.g. 16×32 photodiodes) and accompanying circuitry to convert the analog signals from the photodiode array to digital data. The photodiode array may be located near the accompanying circuity to reduce parasitic inductance and capacitance. Increased distance between the photodiode array and the accompanying circuitry may also increase susceptibility to noise, leading to image degradation.

At lower CT system resolutions, two rows of photodiode arrays may be sufficient, in which case the photodiode arrays may be adjacent to one another, and the accompanying circuitry may be arranged around the perimeter of the photodiode arrays. Advancements in CT systems have led to higher resolution imaging, which may require more than two rows of photodiode arrays. Any gap between photodiode arrays will result in a gap in the CT image, so CT systems requiring more than a two-row array of photodiodes require a different approach.

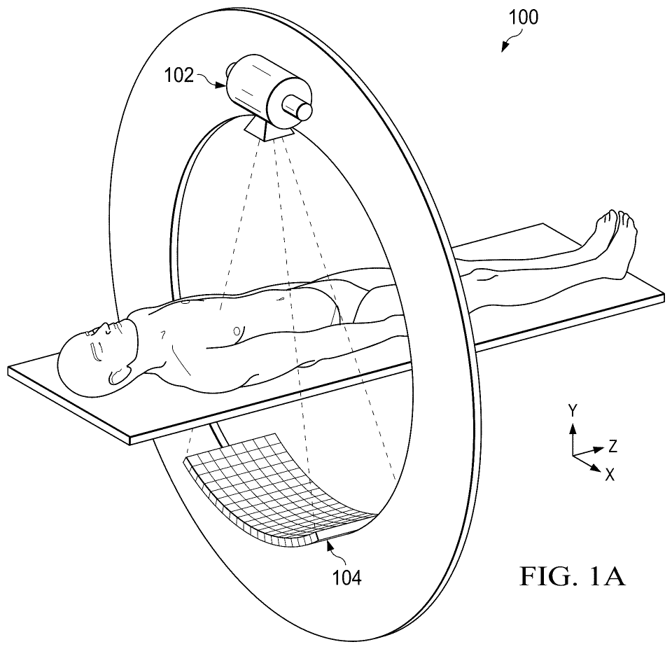

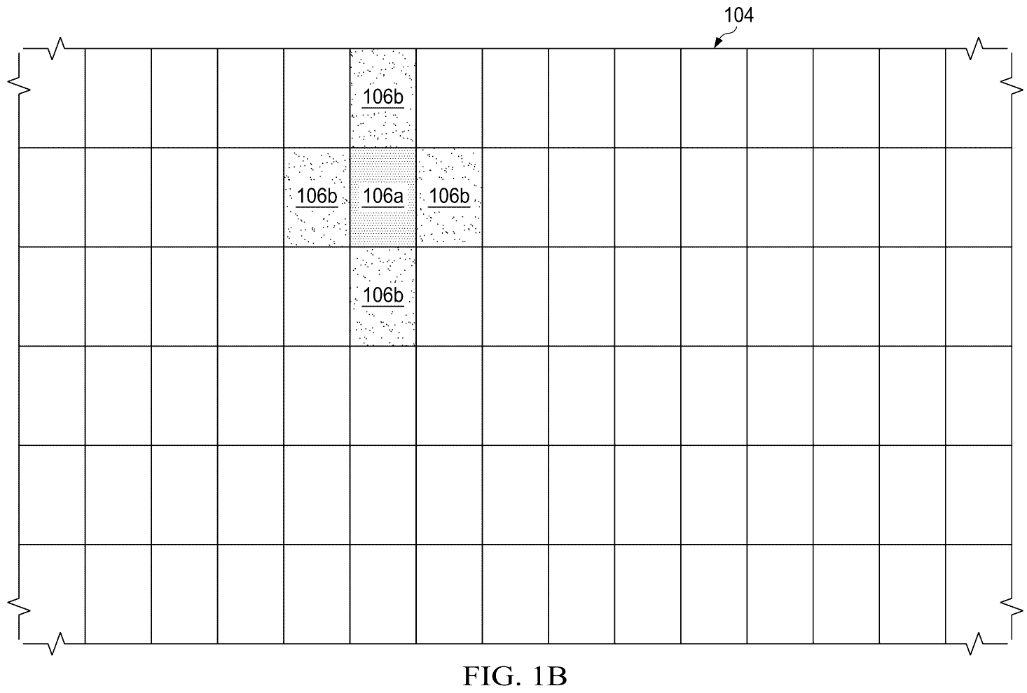

FIG. 1A shows one example of a CT system 100 with an electromagnetic radiation emitter 102 and an electronic system array 104 with more than two rows. FIG. 1B shows a top view of the electronic system array 104. An electronic system 106a is surrounded by other electronic systems 106b. Photodiode array of the electronic system 106a may be on a front side of the electronic system 106a and accompanying circuitry (not shown) of the electronic system 106a may be placed at a backside of the electronic system 106a.

The accompanying circuitry located at the backside of the electronic system 106a may be exposed to electromagnetic radiation from the electromagnetic radiation emitter 102. Electromagnetic radiation may have an adverse effect on the accompanying circuitry, so a shield may be needed. The physical placement of shield material, as well as additional cost, need to be considered.

Some possible solutions include a two-layer flexible chip on film (COF) to couple the photodiode array to the accompanying circuitry. Two-layer flexible COFs may be cost prohibitive for large electronic system arrays. Other solutions include a printed circuit board (PCB) directly under the photodiode array that routes the photodiode outputs directly to the accompanying circuitry. Due to the large number of photodiodes, the PCB may have high routing density, which may increase the cost. Still other solutions include a photodiode array coupled directly to the backside of the accompanying circuitry. Through silicon vias (TSVs) may be used to route the photodiode outputs to the accompanying circuitry. This approach may increase production cost of the accompanying circuitry, as well as increase a total semiconductor die area required since the photodiode array may be larger than an area required for the accompanying circuity.

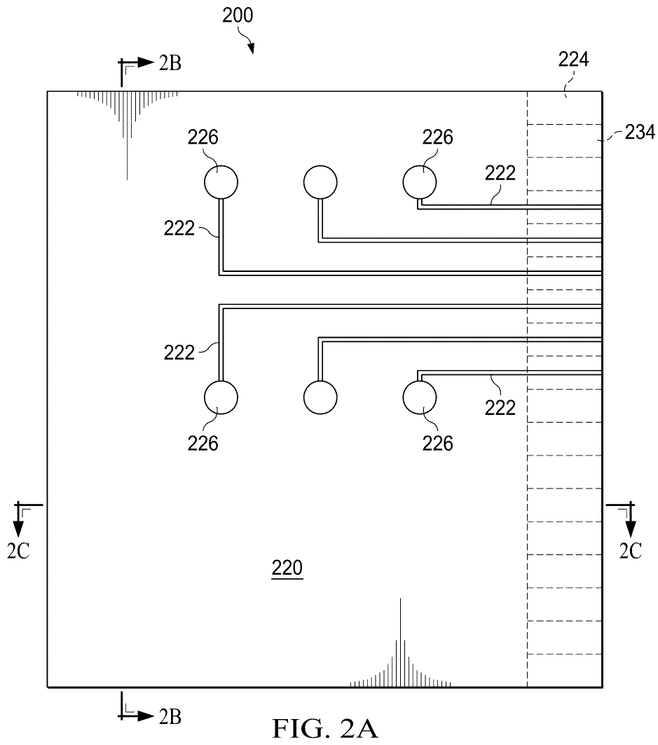

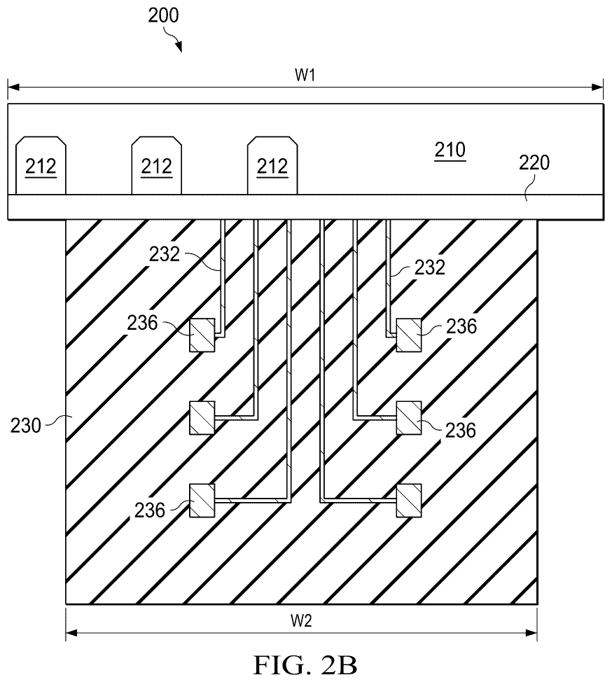

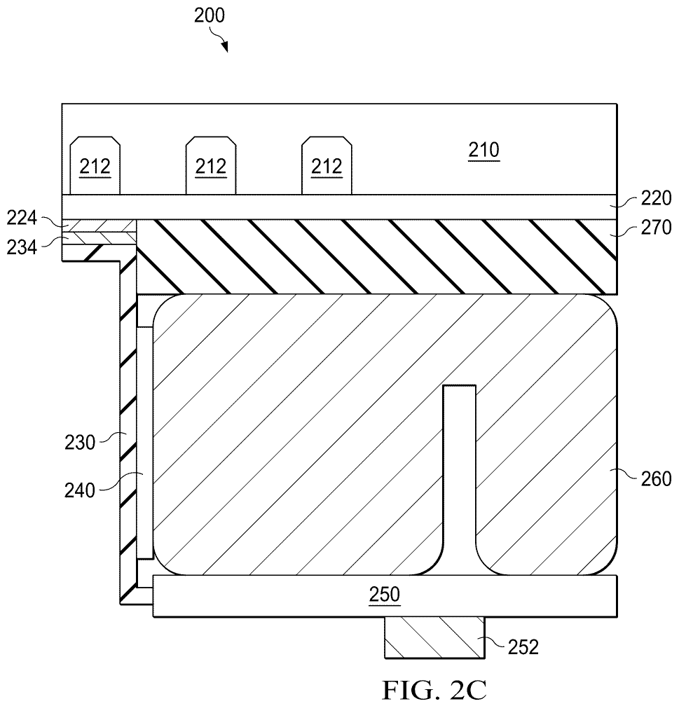

FIG. 2A is a top-down view of an electronic system 200, in accordance with certain aspects of the present disclosure. FIG. 2B is a cross-sectional view of the electronic system 200 of FIG. 2A taken along cut line 2B-2B, in accordance with certain aspects of the present disclosure. The electronic system 200 comprises a photodiode array 210 (not shown in FIG. 2A) including photodiodes 212 and photodiode contacts (not shown). The photodiode array 210 may be a back illuminated photodiode array, wherein silicon is thinned to a thickness (e.g. less than 100 microns) sufficient to allow light to pass through backside of the silicon to an active area on the opposite surface. A back illuminated photodiode array may be thinned by any known method, such as backgrinding.

The photodiode array 210 may couple to a redistribution layer (RDL) 220. RDL pads 226 of the RDL 220 are coupled to the photodiode contacts (not shown) of the photodiode array 210. RDL traces 222 couple the RDL pads 226 to RDL contacts 224. The RDL contacts 224 may be located near an edge of the RDL 220. The RDL 220 may be coupled to the photodiode array 210 during the manufacturing process of the photodiode array 210. The RDL 220 may include insulating layers (e.g. polyimide) and the RDL traces 222 may comprise a suitable conductor (e.g. copper).

A single layer flexible COF 230 has COF traces 232 on only one surface. The COF traces 232 may be a single conductive layer formed from a suitable conductor (e.g. copper) on one side of a flexible insulating substrate (e.g. polyimide). A single layer COF may offer a cost advantage compared to a dual layer COF, as well as simplified manufacturability. The COF traces 232 couple accompanying circuitry (not shown) to COF contacts 234 along one edge of the flexible COF 230. The RDL 220 is coupled to the flexible COF 230 by bonding the RDL contacts 224 and the COF contacts 234 by any suitable means, such as anisotropic conductive film (ACF), for example.

The RDL pads 226 couple the photodiode array 210 to the RDL 220. COF pads 236 couple the accompanying circuitry to the flexible COF 230. The RDL 220 may have a first width W1 corresponding to a width of the photodiode array 210. The flexible COF 230 may have a second width W2 corresponding to a width of the COF contacts 234, wherein W2 is smaller than W1. The second width W2 of the flexible COF 230 being less than the first width W1 of the RDL 220 may enable a cheaper and smaller electronic system 200.

FIG. 2C is another cross-sectional view of the electronic system 200 shown in FIG. 2A taken along cut line 2C-2C, in accordance with certain aspects of the present disclosure. The photodiode array 210 is coupled to the RDL 220, which is coupled to the flexible COF 230. Alternatively, the photodiode array 210 may be coupled directly to the flexible COF 230 through the photodiode contacts (not shown) routed to an edge of the photodiode array 210, eliminating the need for the RDL 220. The flexible COF 230 may be pre-flexed to approximately 90 degrees to reduce stress on the photodiode array 210 when the electronic system 200 is assembled. The flexible COF 230 may be single-layer, and flex such that the surface with the COF pads 236 faces an interior of the electronic system 200. An integrated circuit 240 (the accompanying circuitry) is coupled to the COF pads 236. The integrated circuit 240 processes the analog signals from the photodiode array 210, for example the integrated circuit 240 may convert the analog signals from the photodiode array 210 to digital signals. The flexible COF 230 enables the integrated circuit 240 to be in close proximity to the photodiode array 210. The flexible COF 230 is also coupled to a PCB 250 on an end opposite the photodiode array 210. The flexible COF 230 is flexed at approximately 90 degrees such that the PCB 250 is positioned below the photodiode array 210. The PCB 250 may include additional circuitry and a connector 252 that allows the electronic system 200 to be connected to an array of electronic systems to be used in a CT system. The data processed by the electronic system 200 passes through the connector 252 to the CT system.

A heat sink 260 is adjacent to the PCB 250 and the integrated circuit 240. The heat sink 260 may be made of any suitable thermally conductive material, such as aluminum. A shield 270 is between the photodiode array 210 and the heat sink 260. The shield 270 is made of a material suitable to protect the integrated circuit 240 and the PCB 250 from electromagnetic radiation, one example of shield material is tungsten.

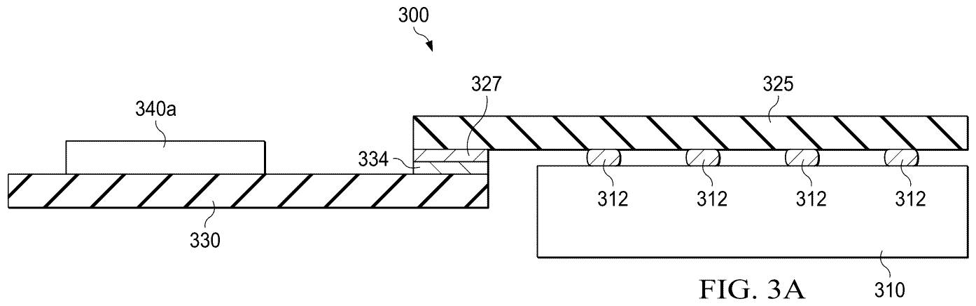

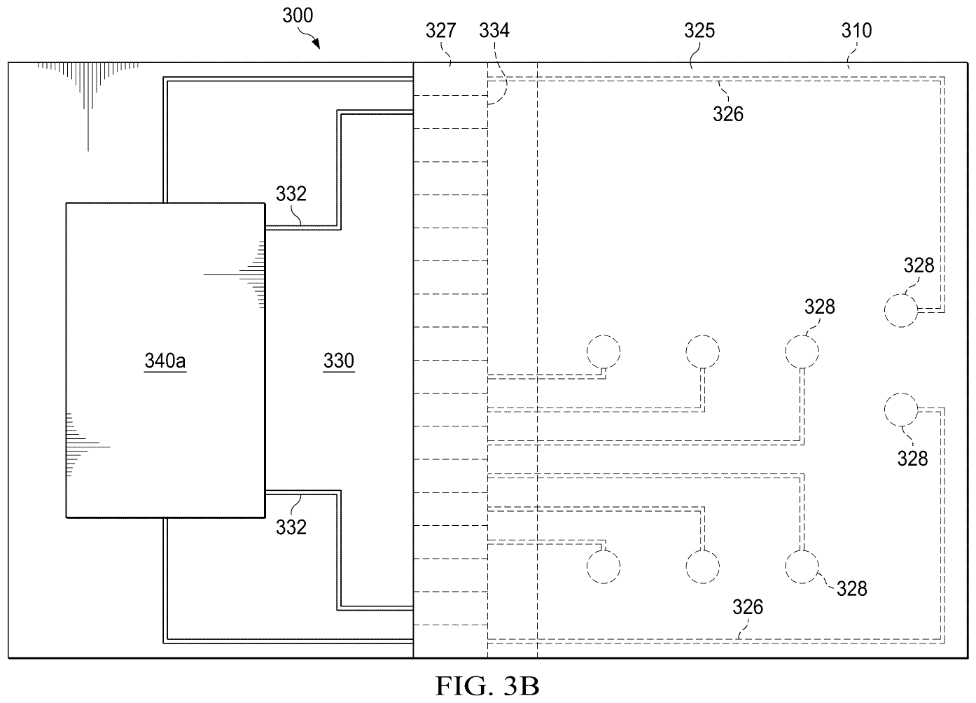

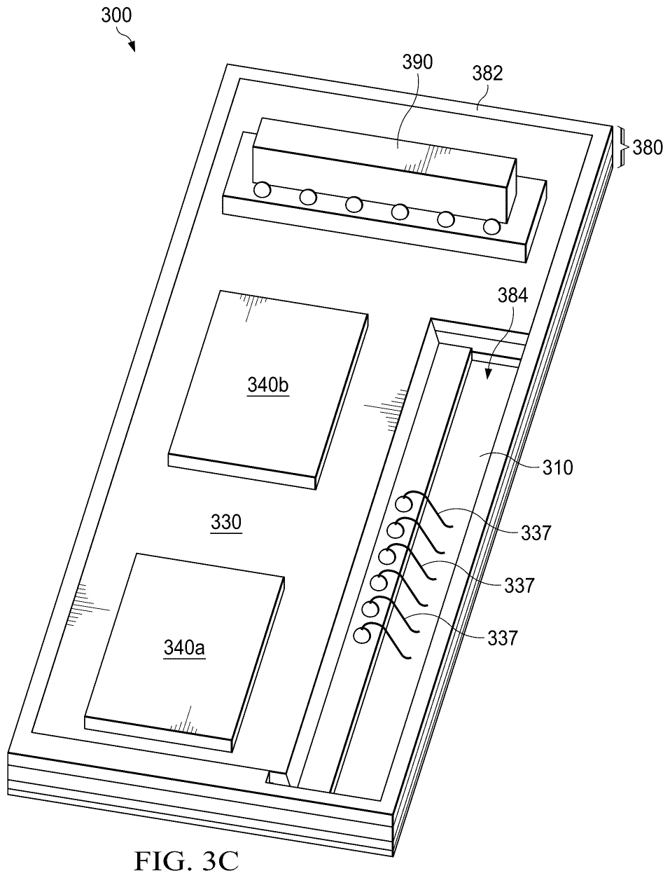

FIGS. 3A and 3B are a cross-sectional view and a top-down view of an example electronic system 300 in accordance with certain aspects of the present disclosure. The electronic system 300 comprises a photodiode array 310 coupled to a single-layer flexible PCB 325. The photodiode array 310 may be coupled to the single-layer flexible PCB 325 through suitable means, such as solder balls 312 coupled to flexible PCB pads 328. The photodiode analog signals are routed from the flexible PCB pads 328 to flexible PCB contacts 327 by flexible PCB traces 326. A first integrated circuit 340a is coupled to a single-layer flexible COF 330. The single-layer flexible PCB 325 and the single-layer flexible COF 330 are coupled together via the flexible PCB contacts 327 aligned with and overlapping flexible COF contacts 334 using any suitable means, such as ACF. A top surface of the photodiode array 310 and a top surface of the first integrated circuit 340a may face opposite directions. The photodiode analog signals are conducted through the flexible COF contacts 334 and flexible COF traces 332 to the first integrated circuit 340a. The single-layer flexible PCB 325 and the single-layer flexible COF 330 may provide a cost advantage over a dual layer flexible COF of suitable size to accommodate the photodiode array 310 and the first integrated circuit 340a on opposite surfaces.

FIG. 3C is a perspective view of the electronic system 300 in accordance with certain aspects of the present disclosure. The photodiode array 310 may be coupled to a flexible PCB (not shown), however it is not required, the photodiode array 310 may be coupled to an electronic system body 380 directly. The electronic system body 380 may comprise multiple layers including, but not limited to, a heat sink (not shown), a shield (not shown), or frame (not shown). The single-layer flexible COF 330 is coupled to an opposite face 382 of the electronic system body 380 from the photodiode array 310. The first integrated circuit 340a and an optional second integrated circuit 340b may be coupled to the single-layer flexible COF 330. The optional second integrated circuit 340b may be included to process analog signals from the photodiode array 310 that comprises too many photodiodes for the first integrated circuit 340a to process, or for other reasons. The single-layer flexible COF 330 extends from the opposite face 382 of the electronic system body 380 through an opening 384 in the electronic system body 380 to the photodiode array 310. The opening 384 may be bounded on four sides by the electronic system body 380, as shown, or the opening 384 may be bounded on three sides by the electronic system body 380. The photodiode array 310 is coupled to the single-layer flexible COF 330 by bondwires 337, or any other suitable means, such as ACF. A connector 390 is coupled to the single-layer flexible COF 330 and allows the electronic system 300 to be connected to an array of electronic systems to be used in a CT system, or other system. Other electronic components (not shown) may also be coupled to the single-layer flexible COF 330 as needed for the proper operation of the electronic system 300.

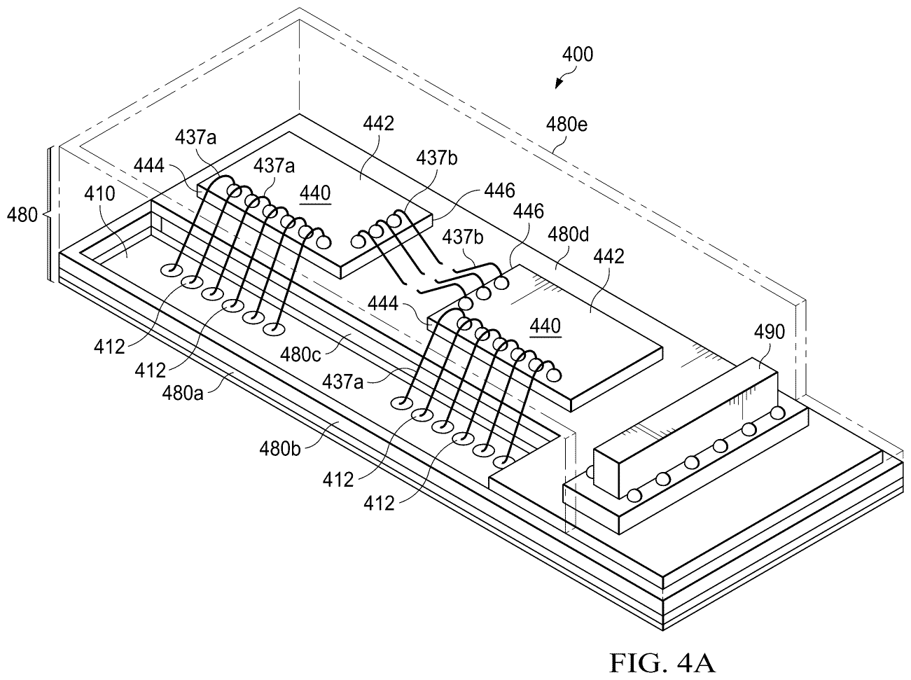

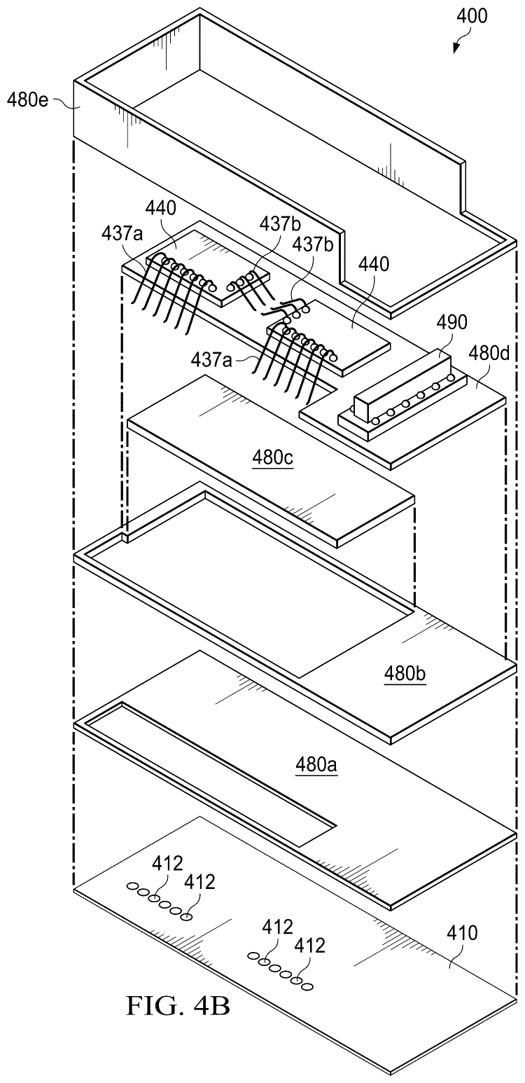

FIGS. 4A and 4B are a perspective view and an exploded view of an example electronic system 400 in accordance with certain aspects of the present disclosure. The electronic system 400 comprises a photodiode array 410 coupled to an electronic system substrate 480. The electronic system substrate 480 may have multiple layers including, but not limited to, a support 480a, a frame 480b, a shield 480c, and a PCB 480d. The support 480a provides structural support for the photodiode array 410. The frame 480b laterally surrounds the shield 480c, the shield 480c shields semiconductor dies 440 from electromagnetic radiation. Layers of the electronic system substrate 480 may have different size and shape. Similar to the electronic system 300, the electronic system 400 may have one or more semiconductor dies 440 as needed for the proper operation of the electronic system 400.

The semiconductor dies 440 may have similar function to the first integrated circuit 340a. Analog signal inputs of the semiconductor dies 440 may be routed to first edges 444 of the semiconductor dies 440 and coupled to bond pads (not shown) on active surfaces 442 of the semiconductor dies 440. Other inputs and outputs of the semiconductor dies 440 may also be coupled to bond pads on the active surfaces 442 along edges 446, or any other edges of the semiconductor dies 440. Similarly, photodiode contacts 412 may be routed to an edge of the photodiode array 410. Bondwires 437a are one option to couple the photodiode contacts 412 to the analog signal inputs along the first edges 444 of the semiconductor dies 440 through an opening in the electronic system substrate 480. Bondwires 437b connect the other input and output signals of the semiconductor dies 440 to the PCB 480d. The bondwires 437a and 437b may be bonded by common bonding methods known in the industry, such as stitch bonding, or other suitable methods. The semiconductor dies 440 may be covered with a protective material (not shown) after the bonding process is complete to protect the active surfaces 442.

A connector 490 is coupled to the PCB 480d and allows the electronic system 400 to be connected to an array of electronic systems to be used in a CT system, or other system. Other electronic components (not shown) may also be coupled to the PCB 480d as needed for the proper operation of the electronic system 400. A case 480e may be included to protect the components of the electronic system 400.

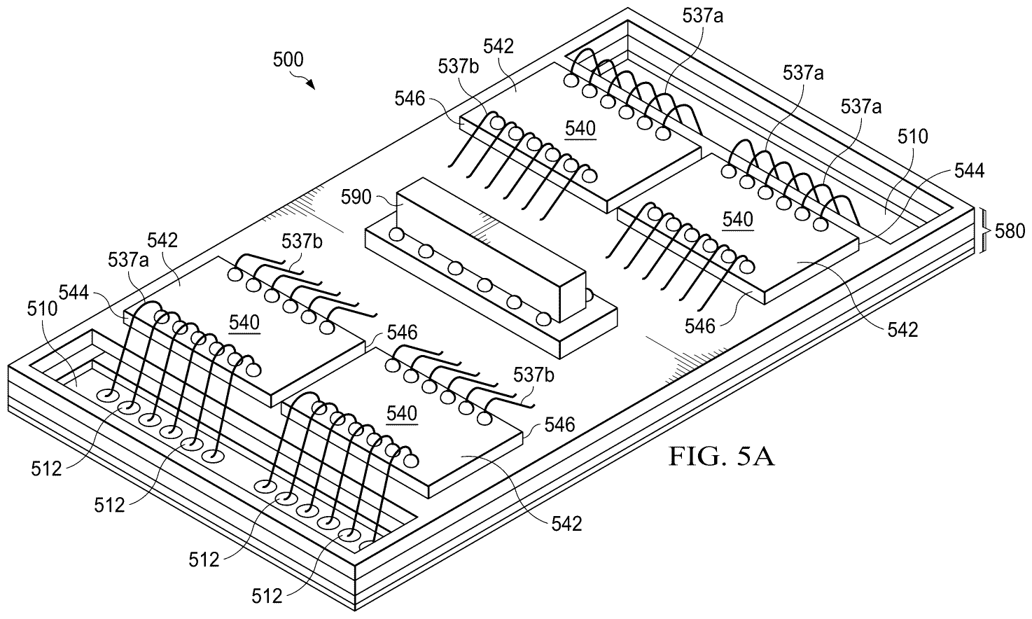

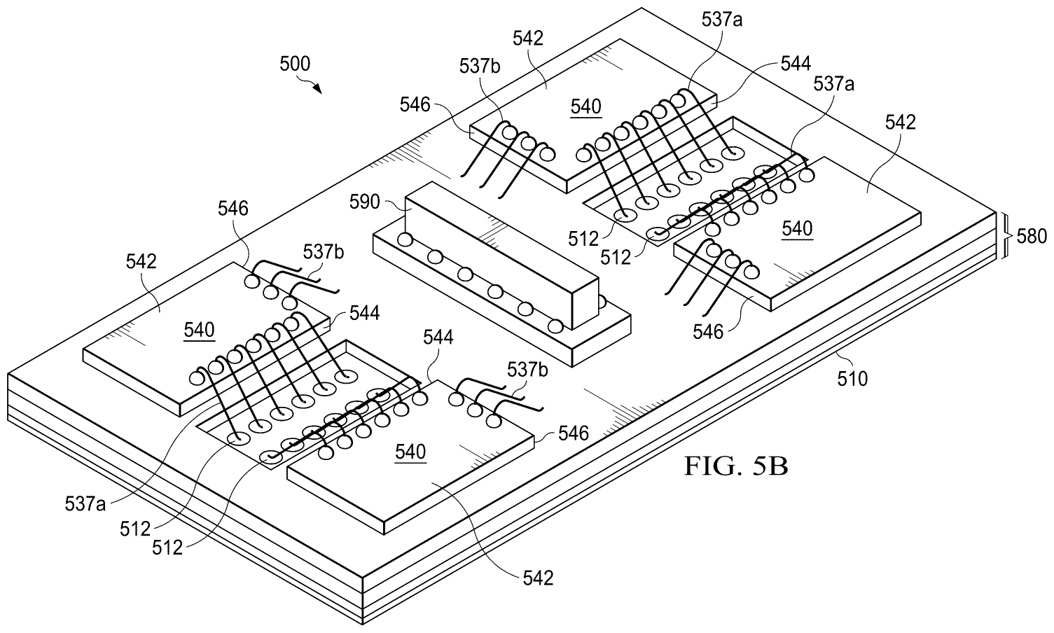

FIGS. 5A and 5B are perspective views of example electronic systems 500 in accordance with certain aspects of the present disclosure. The electronic system 500 includes a photodiode array 510 coupled to an electronic system substrate 580. The electronic system substrate 580 may have multiple layers (not shown) including, but not limited to, a support, a frame, a shield, and a PCB. Layers of the electronic system substrate 580 may have different size and shape. Similar to the electronic system 400, the electronic system 500 may have one or more semiconductor dies 540 as needed for the proper operation of the electronic system 500. For purposes of illustration the electronic system 500 is described as having multiple semiconductor dies 540.

The semiconductor dies 540 may have similar function to the first integrated circuit 340a. Analog signal inputs of the semiconductor dies 540 may be routed to first edges 544 of the semiconductor dies 540 and coupled to bond pads (not shown) on active surfaces 542 of the semiconductor dies 540. Other inputs and outputs of the semiconductor dies 540 may also be coupled to bond pads on the active surfaces 542 along edges 546, or any other edges of the semiconductor dies 540. Similarly, as shown in FIG. 5A, photodiode contacts 512 may be routed to two or more edges of the photodiode array 510. Alternatively, as shown in FIG. 5B, photodiode contacts 512 may be routed to an inner portion of the photodiode array 510. Bondwires 537a are one option to couple the photodiode contacts 512 to the analog signal inputs on the active surfaces 542 of the semiconductor dies 540 through an opening in the electronic system substrate 580. Bondwires 537b connect the other input and output signals of the semiconductor dies 540 to the electronic system substrate 580. The bondwires 537a and 537b may be bonded by common bonding methods known in the industry, such as stitch bonding, or other suitable methods. The semiconductor dies 540 may be covered with a protective material (not shown) after the bonding process is complete to protect the active surfaces 542.

A connector 590 is coupled to the electronic system substrate 580 and allows the electronic system 500 to be connected to an array of electronic systems to be used in a CT system, or other system. Other electronic components (not shown) may also be coupled to the electronic system substrate 580 as needed for the proper operation of the electronic system 500. A case (not shown) may be included to protect the components of the electronic system 500.

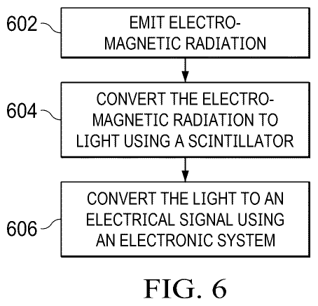

FIG. 6 illustrates a method of using a CT system in accordance with certain aspects of the present disclosure. Electromagnetic radiation is emitted by an electromagnetic radiation emitter (602). The electromagnetic radiation is then received at a scintillator that converts the electromagnetic radiation to light (604). An electronic system converts the light to analog signals with a photodiode array, then further converts the analog signals to digital signals with accompanying circuitry (606). Any electronic system according to the present disclosure would be appropriate for a CT system.

Those skilled in the art to which this disclosure relates will appreciate that many variations of disclosed aspects are possible within the scope of the claimed invention, and further additions, deletions, substitutions, and modifications may be made to the above-described aspects without departing from the scope of this disclosure.

What is claimed is:

1. An electronic system, comprising:
a substrate having a first surface and a second surface, the second surface opposite the first surface;
a first semiconductor die on the first surface; and
a second semiconductor die on the second surface, wherein the first semiconductor die and the second semiconductor die are coupled through an opening in the substrate by a bondwire.

2. The electronic system of claim 1, wherein the first semiconductor die comprises a photodiode.

3. The electronic system of claim 1, wherein the substrate comprises a tungsten layer.

4. The electronic system of claim 1, further comprising:
a first plurality of contacts on the first semiconductor die; and
a second plurality of contacts on the second semiconductor die,
wherein the first plurality of contacts and the second plurality of contacts are coupled together by a first plurality of bondwires.

5. The electronic system of claim 4, wherein the first plurality of contacts is near an edge of the first semiconductor die, and the second plurality of contacts is near an edge of the second semiconductor die.

6. The electronic system of claim 5, further comprising:
a third semiconductor die on the second surface;
a third plurality of contacts near an edge of the third semiconductor die; and
a fourth plurality of contacts near the edge of the first semiconductor die, wherein the third plurality of contacts and the fourth plurality of contacts are coupled together by a second plurality of bondwires.

7. The electronic system of claim 4, wherein the first plurality of contacts is in an inner portion of the first semiconductor die, and the second plurality of contacts is near an edge of the second semiconductor die.

8. The electronic system of claim 7, further comprising:
a third semiconductor die on the second surface;
a third plurality of contacts near an edge of the third semiconductor die; and
a fourth plurality of contacts in the inner portion the first semiconductor die, wherein the third plurality of contacts and the fourth plurality of contacts are coupled together by a second plurality of bondwires.

9. A computed tomography (CT) system, comprising:
an electromagnetic radiation emitter; and
an electronic system, wherein the electronic system includes:
a substrate having a first surface and a second surface, the second surface opposite the first surface;
a first semiconductor die on the first surface; and
a second semiconductor die on the second surface, wherein the first semiconductor die and the second semiconductor die are coupled through an opening in the substrate by a bondwire.

10. A method of using a computed tomography (CT) system, comprising:
emitting an electromagnetic radiation signal;
receiving the electromagnetic radiation signal at a scintillator;
converting the received electromagnetic radiation signal to light using the scintillator; and
converting the light to an electrical signal using an electronic system, wherein the electronic system includes:
a substrate having a first surface and a second surface, the second surface opposite the first surface;
a first semiconductor die on the first surface; and
a second semiconductor die on the second surface, wherein the first semiconductor die and the second semiconductor die are coupled through an opening in the substrate by a bondwire.

11. An electronic system, comprising:
a flexible film;
a first electronic device coupled to a first surface of the flexible film through a first plurality of contacts, wherein the first plurality of contacts is arranged along an edge of the first electronic device; and
a second electronic device coupled to the first surface of the flexible film.

12. The electronic system of claim 11, wherein a width of the first electronic device is greater than a width of the flexible film.

13. The electronic system of claim 11, further comprising a body, wherein the first electronic device is on a first surface of the body, and the second electronic device is on a second surface of the body.

14. The electronic system of claim 13, wherein the first surface of the body is perpendicular to the second surface of the body.

15. The electronic system of claim 13, wherein the body comprises a heat sink.

16. The electronic system of claim 13, wherein the body comprises an electromagnetic shield.

17. The electronic system of claim 13, wherein the body comprises a printed circuit board.

18. A computed tomography (CT) system, comprising:
an electromagnetic radiation emitter; and
an electronic system, wherein the electronic system includes:
a flexible film;
a first electronic device coupled to a first surface of the flexible film through a first plurality of contacts, wherein the first plurality of contacts is arranged along an edge of the first electronic device; and
a second electronic device coupled to the first surface of the flexible film.

19. A method of using a computed tomography (CT) system, comprising:
emitting an electromagnetic radiation signal;
receiving the electromagnetic radiation signal at a scintillator;
converting the received electromagnetic radiation signal to light using the scintillator; and
converting the light to an electrical signal using an electronic system, wherein the electronic system includes:
a flexible film;
a first electronic device coupled to a first surface of the flexible film through a first plurality of contacts, wherein the first plurality of contacts is arranged along an edge of the first electronic device; and
a second electronic device coupled to the first surface of the flexible film.

20. An electronic system, comprising:
a body having a first surface and a second surface, the second surface opposite the first surface;
a first flexible film, a first portion of the first flexible film on the first surface;
a first electronic device on the first portion of the first flexible film;
a first contact on a second portion of the first flexible film; and
a second electronic device on the second surface of the body, the second electronic device having a second contact, wherein the first contact is coupled to the second contact through an opening in the body.

21. The electronic system of claim 20, wherein the second electronic device comprises a photodiode, and wherein the second contact is near an edge of the second electronic device.

22. The electronic system of claim 20, wherein the first contact and the second contact are coupled together by a bondwire.

23. The electronic system of claim 20, wherein the first contact and the second contact are coupled together by an anisotropic conductive film (ACF).

24. The electronic system of claim 20, wherein the second electronic device comprises:
a second flexible film, wherein the second contact is on the second flexible film near an edge of the second flexible film.

25. The electronic system of claim 20, wherein the body comprises an electromagnetic shield.

26. A computed tomography (CT) system, comprising:
an electromagnetic radiation emitter; and
an electronic system, wherein the electronic system includes:
a body having a first surface and a second surface, the second surface opposite the first surface;
a first flexible film, a first portion of the first flexible film on the first surface;
a first electronic device on the first portion of the first flexible film;
a first contact on a second portion of the first flexible film; and
a second electronic device on the second surface of the body, the second electronic device having a second contact, wherein the first contact is coupled to the second contact through an opening in the body.

27. A method of using a computed tomography (CT) system, comprising:
emitting an electromagnetic radiation signal;
receiving the electromagnetic radiation signal at a scintillator;
converting the received electromagnetic radiation signal to light using the scintillator; and
converting the light to an electrical signal using an electronic system, wherein the electronic system includes:
a body having a first surface and a second surface, the second surface opposite the first surface;
a first flexible film, a first portion of the first flexible film on the first surface;
a first electronic device on the first portion of the first flexible film;
a first contact on a second portion of the first flexible film; and
a second electronic device on the second surface of the body, the second electronic device having a second contact, wherein the first contact is coupled to the second contact through an opening in the body.
